(19) United States
(12) Patent Application Publication
(10) Pub. No.: US 2015/0229049 A1
(43) Pub. Date: Aug. 13, 2015

(54) ELECTRICAL CONNECTOR

(71) Applicant: ADVANCED-CONNECTEK INC., New Taipei City (TW)

(72) Inventors: Ching-Tien Chen, New Taipei City (TW); Shu- Lin Duan, New Taipei City (TW); Wei Wan, New Taipei City (TW); Ping-Chuan Chu, New Taipei City (TW); Xiao- Juan Qi, New Taipei City (TW)

(21) Appl. No.: 14/536,665

(22) Filed: Nov. 9, 2014

(30) Foreign Application Priority Data
Feb. 7, 2014 (CN) 201410044580.4

(51) Int. Cl. H01R 12/70

(52) U.S. Cl. CPC H01R 12/7005

(57) ABSTRACT

A board-to-wire connector for a circuit board includes a plastic body, two narrow metal brackets, and multiple conductive terminals. The plastic body has a connection plate, a raised portion, and two coupling portions at two opposite sides of the raised portion. The raised portion defines multiple channels. Each coupling portion is formed at its front with an upright support that has an enlarged top end. The two narrow metal brackets are provided for mounting with the coupling portions of the plastic body. Each narrow metal bracket has a main plate, front and rear interference tabs for being interfered with one coupling portion of the plastic body, and at least one positioning tab for being fixed onto the circuit board. Multiple conductive terminals are fitted through the channels of the raised portion, wherein each conductive terminal has a fixed section, a solder section, and a connecting section.

### FIELD OF THE INVENTION

The present invention relates to an electrical connector to be installed at a circuit board for connecting with a wire-to-board connector installed at a cable.

### BACKGROUND OF THE INVENTION

Connectors are a circuit component that provides electrical connection between different electronic devices, so that electrical current or signal can be transmitted between the devices and thus enables the devices to communicate with each other. Since electronic devices are usually separated at a certain distance, cables are required for communication therebetween. To facilitate a connection, each cable and its associated circuit board need to be installed with a connector. Generally, the connector installed at a cable is called a wire-to-board connector while the connector installed at a circuit board is called a board-to-wire connector. Although the functions of both connectors are simple, they are usually applied in the circuits of electronic products.

Since the space relationship between a cable and a circuit board may be changed with the locations of the associated electronic devices, the structural strength of those connectors is important and necessary for ensuring a stable communication therebetween. On the other hand, due to the highly competition of electronic components, the cost is a key point for maintaining the competitiveness of connector components on the market.

The quality, stability, and material saving of a board-to-wire connector will affect the service life, performance, and market acceptance of the associated electronic product. As shown in FIG. 1, an existing board-to-wire connector 6 comprises an insulation body 61, a plurality of conductive terminals 62 extending in a longitudinal direction of the insulation body 61, and a metal support 63 for supporting the insulation body 61. To achieve a robust design, the metal support 63 is formed with a large flat plate 632 in addition to the attachment pieces 631 formed at two opposite sides thereof, so that the metal support 63 can provide a full protection for the insulation body 61. Also, with the attachment pieces 631 of the metal support 63, the existing board-to-wire connector 6 can be installed onto a circuit board (not shown).

With slim and light demand on electronic products, board-to-wire connectors installed at electronic products need continuous process. In the existing board-to-wire connector 6, since the large flat plate 632 of the metal support 63 has occupied some height of the connector, the insulation body 61 of the connector should be reduced in its thickness to achieve the purpose of reducing the connector's height, thereby causing inadequate structural strength of the insulation body 61. Consequently, the existing board-to-wire connector 6 is liable to be damaged upon an improper force is applied, so that the service life of the connector may be reduced, thus causing troubles to users. Besides, since the molding cavity for the insulation body 61 of the connector is too narrow, bubbles are liable to form in the insulation body 61 during the molding process, thereby reducing the product yield. Also, since the metal support 63 with a large flat plate 632 requires more metal material, the manufacturing cost of the connector will be increased.

In consideration of assembling the elements of the existing board-to-wire connector, since the metal support 63 is assembled to the insulation body 61 and the conductive terminals 62 are assembled to the insulation body 61, as mentioned above, the insulation body 61 should be limited in its thickness for reducing the height of the connector, so that the structural strength of the connector may be poor. Therefore, an improper force may cause damages to the insulation body 61, thereby decreasing the product yield and thus affecting the cost reduction.

For solving the foregoing problems, the applicant has contrived an improved board-to-wire connector, which can save metal material to reduce the manufacturing cost while the plastic body used in the improved connector can still have an adequate thickness and strength, so as to increase the product yield, enhance the product strength, extend the product's service life, and reduce the damages of the plastic body, so that the improved connector has a considerable effect over conventional technology.

### SUMMARY OF THE INVENTION

One aspect of the present invention is to provide a board-to-wire connector, which has an increased thickness of a plastic body even under a height limitation thereof, so that the production yield can be increased.

Another aspect of the present invention is to provide a board-to-wire connector, which has an increased strength and a reduced damage rate in the assembling process, so that the assembly yield can be increased.

A further aspect of the present invention is to provide a board-to-wire connector, which can lower the manufacturing cost by reducing the amount of metal material being used in the connector.

A still further aspect of the present invention is to provide a board-to-wire connector, which includes a plastic body having two coupling portions at its two opposite sides, wherein each coupling portion defines an engaging recess at its front and a positioning recess at its rear respectively for interfering engagement with the front and rear interference tabs of one narrow metal bracket, so that the plastic body and the narrow metal brackets can be assembled more tightly, so that the structural strength of the board-to-wire connector can be increased.

To achieve the above aspects, the present invention provides a board-to-wire connector for a circuit board, which comprises a plastic body having a connection plate, a raised portion and two coupling portions at two opposite sides of the raised portion, wherein the raised portion defines multiple channels extending in a longitudinal direction thereof, and each coupling portion is formed at its front with an upright support that has an enlarged top end, away from the connection plate; a pair of narrow metal brackets, each corresponding to one of the coupling portions, wherein each of the narrow metal brackets comprises: a main plate connected to outer and bottom sides of the coupling portion corresponding thereto; front and rear interference tabs extending from the main plate and coupled to the coupling portion; and at least one positioning tab disposed at an outer side of the main plate and adapted for engagement with the circuit board; and multiple conductive terminals, each being fitted through a corresponding one of the channels along the longitudinal direction, wherein each of the conductive terminals has a fixed section disposed within the channel corresponding thereto, a solder section extending backwardly from the fixed section for being soldered onto the circuit board, and a connecting section extending forwardly from the fixed section and protruding beyond the plastic plate.

The board-to-wire connector disclosed in the present invention allows the plastic body to have an increased thickness, so that the connector can withstand multiple repeated connections and disconnections. On one hand, each coupling portion of the plastic body defines an engaging recess and an positioning recess respectively at its front and rear to be respectively engaged with the front and rear interference tabs of one narrow metal bracket, so that the plastic body and the narrow metal brackets can be assembled more tightly, so that the structural strength of the board-to-wire connector can be increased. On the other hand, the metal material used in the present invention can be reduced, so that the manufacturing cost can be reduced and the product yield can be increased.

### BRIEF DESCRIPTION OF THE DRAWINGS

FIG. 1 shows an exploded view of a prior-art connector.

FIG. 2 shows a 3-dimensional view of an electrical connector according to one embodiment of the present invention.

FIG. 3 shows a 3-dimensional view of a plastic body used in the electrical connector of the embodiment of the present invention.

FIG. 4 shows a side view of the electrical connector of the embodiment of the present invention.

FIG. 5 shows a top view of a narrow metal bracket used in the electrical connector of the embodiment of the present invention.

FIG. 6 shows a bottom view of the electrical connector of the embodiment of the present invention.

FIG. 7 shows an exploded view of the electrical connector of the embodiment of the present invention.

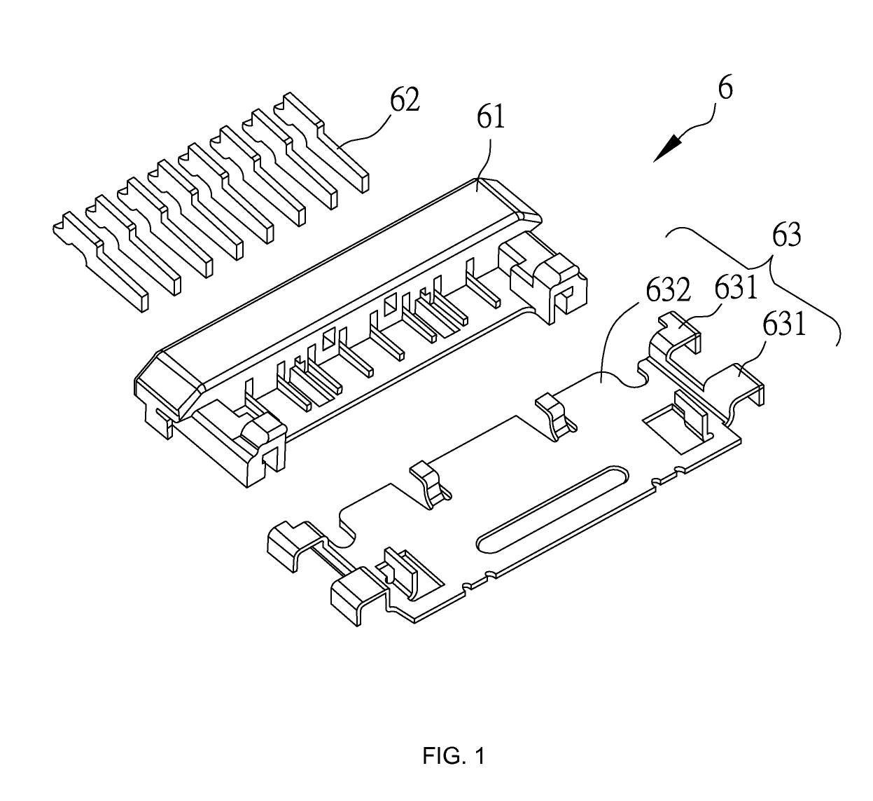

The foregoing and other features and advantages of illustrated embodiment of the present invention will be more readily apparent from the following detailed description, which proceeds with reference to the accompanying drawings.

### DETAILED DESCRIPTION OF THE ILLUSTRATED EMBODIMENTS

The following paragraphs will illustrate a preferred embodiment with reference to the accompanying drawings to demonstrate the technical contents, features, and merits of the present invention. In the preferred embodiment, same elements will be indicated by similar reference numerals.

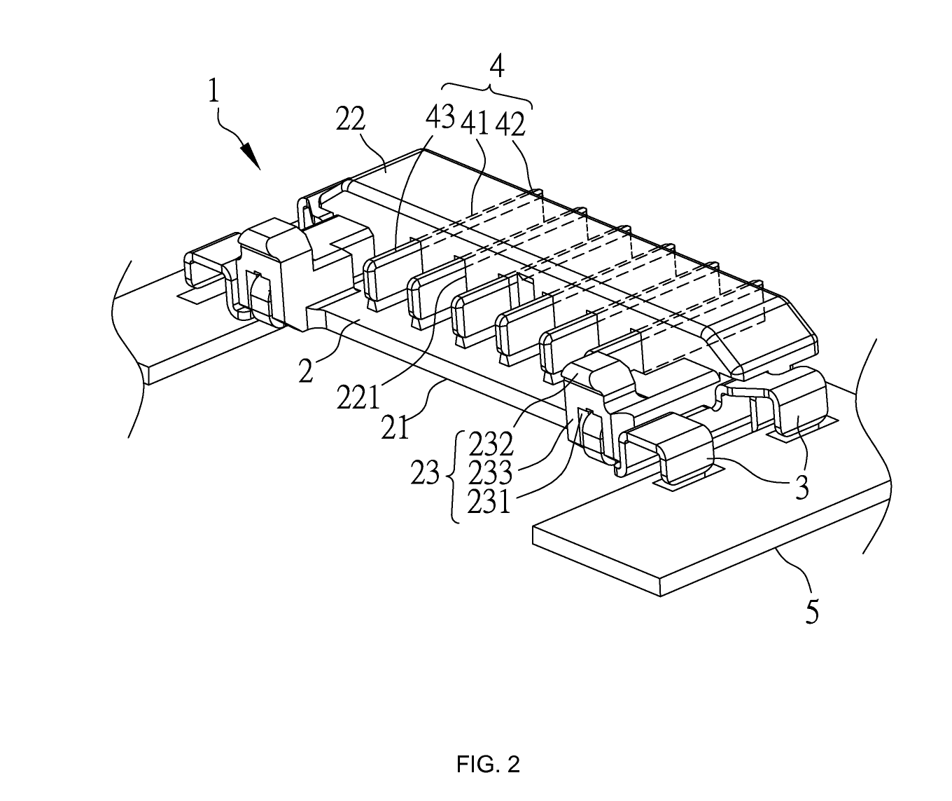

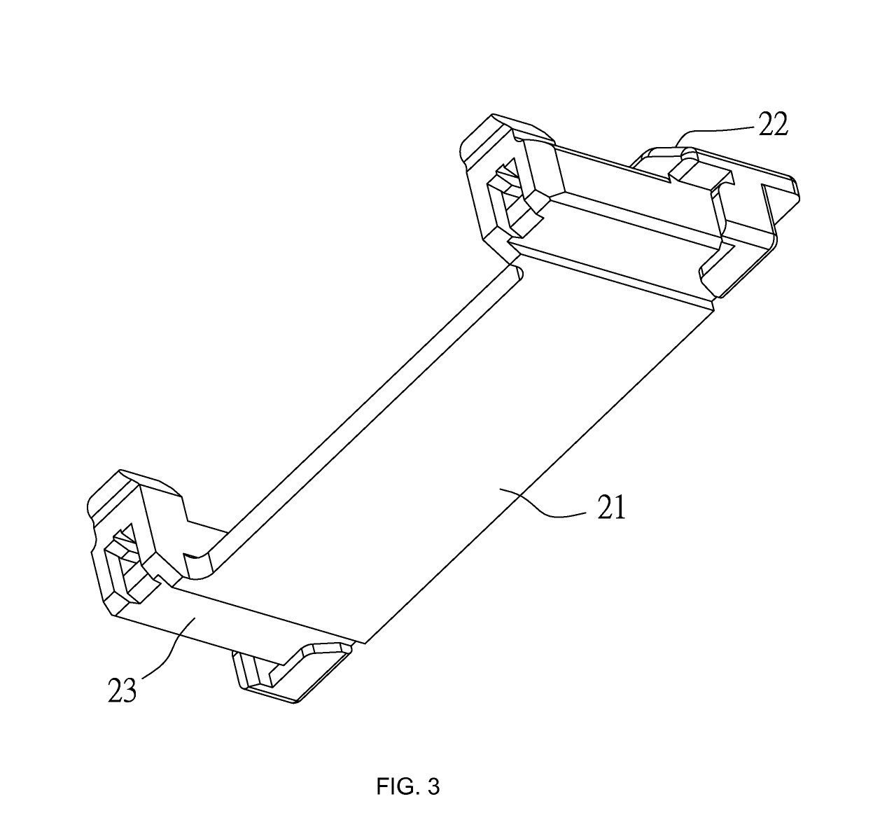

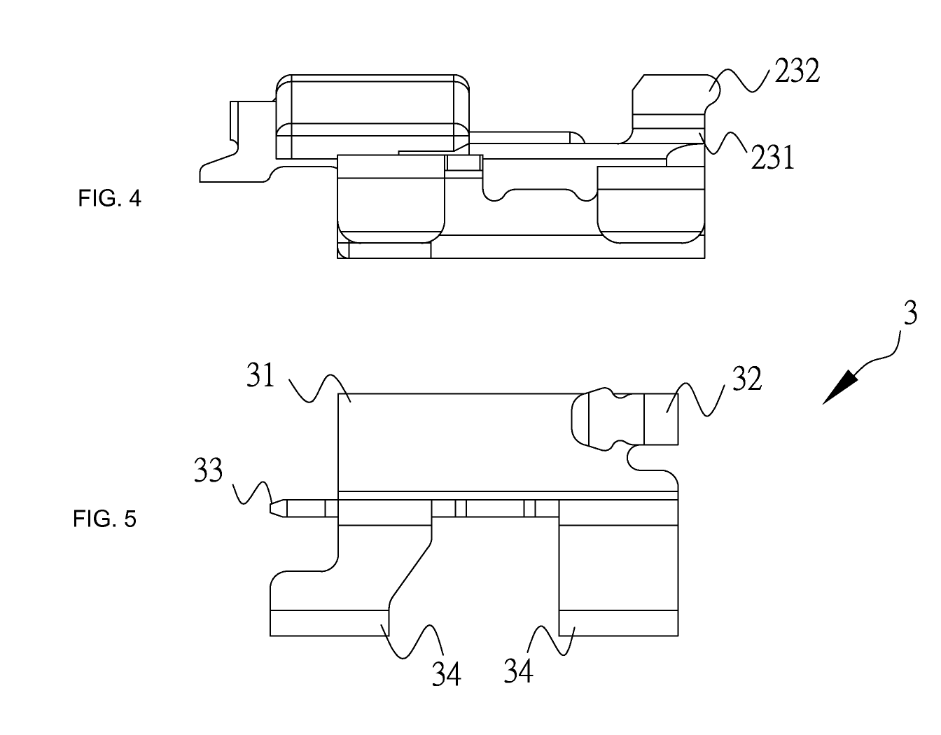

Referring to FIGS. 2 through 4, a board-to-wire connector according to the preferred embodiment of the present invention is shown, which generally comprises a plastic body 2, a pair of narrow metal brackets 3, and multiple conductive terminals 4. The plastic body 2 is made of dielectric material, which is electrically insulated under general household voltage and current. In the embodiment, the plastic body 2 is injection molded from plastic material having a dielectric characteristic.

The plastic body 2 has a connection plate 21, a raised portion 22 at the rear of the connection plate 21, and two coupling portions 23 at two opposite sides of the raised portion 22. The raised portion 22 defines multiple channels 221 extending in a longitudinal direction thereof for being fitted with the multiple conductive terminals 4, wherein each conductive terminal 4 has a fixed section 41 to be disposed in one channel 221 of the raised portion 22, a solder section 42 extending backwardly from the fixed section 41 to be soldered onto a circuit board 5 so that the board-to-wire connector can be electrically connected with the circuit board 5, and a connecting section 43 extending forwardly from the fixed section 41 and protruding out of the channel 221 of the raised portion 22, over the connection plate 21, to be electrically connected with a conductive terminal of a wire-to-board connector (not shown); more especially, the connecting sections 43 of the conductive terminals 4 will not be subject to a downward force during a connecting operation of the board-to-wire connector 1 and the wire-to-board connector, so that damages to the connecting sections 43 will not occur. Furthermore, each coupling portion 23 is formed at its front with an upright support 231 so that a wire-to-board connector can be positioned with the board-to-wire connector 1. Besides, each upright support 231 has an enlarged top end 232, away from the connection plate 21, which allows the board-to-wire connector 1 and a wire-to-board connector to be fixed together, and thus the wire-to-board connector will not be easy to detach from the board-to-wire connector 1 after a connection is established.

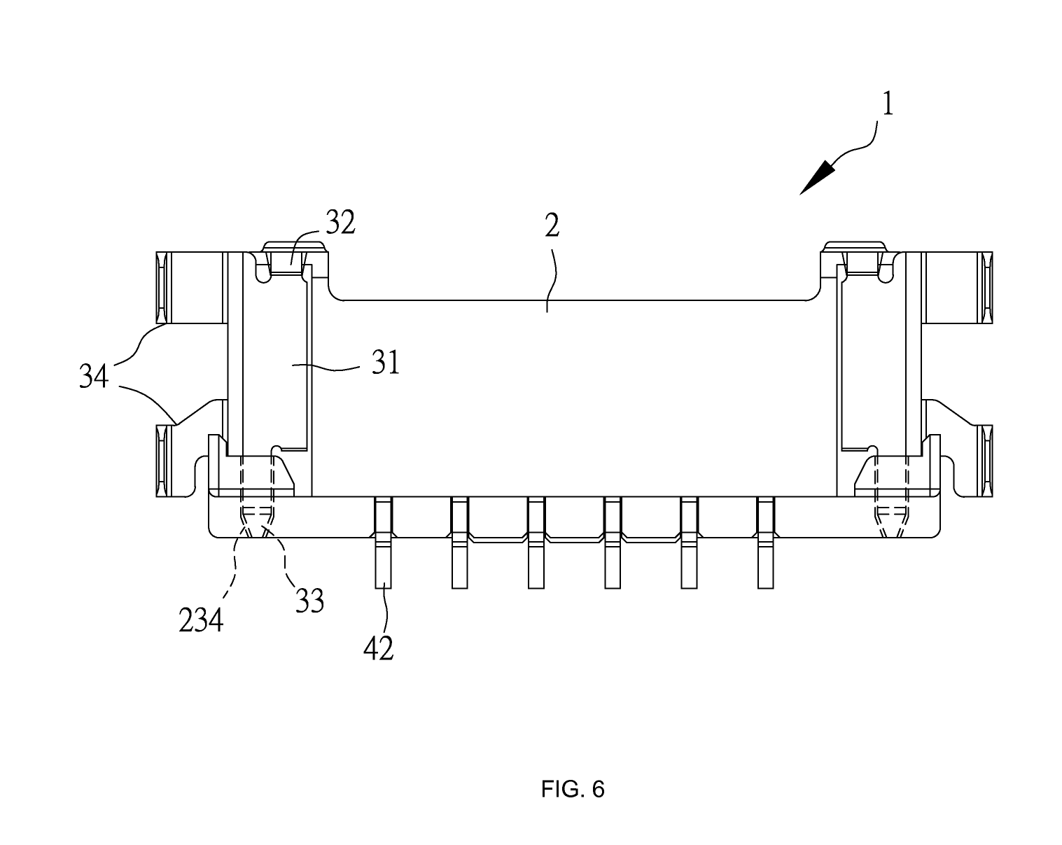

Referring to FIGS. 5 and 6, the narrow metal brackets 3, which may be formed by bending a metal sheet, are provided for connection to the outer and bottom sides of the coupling portions 23. Each narrow metal bracket 3 has a main plate 31, a front interference tab 32 extending from the main plate 31, a rear interference tab 33, and at least one positioning tab 34 at an outer side of the main plate 31. The main plate 31 is substantially L-shaped and used to support the entire board-to-wire connector 1 to prevent the connector from damage when an improper force is applied. Furthermore, the upright support 231 defines an engaging recess 233 at its bottom (see FIG. 2), which can be inserted with the front interference tab 32 being bent upwardly from the main body 31. Also, each coupling portion 23 defines at its rear a positioning recess 234, which can be inserted with the rear interference tab 33. By virtue of the structural arrangement described above, the narrow metal brackets 3 can be firmly fixed to the plastic body 2, so that the board-to-wire connector 1 can be strengthened to prevent damages even though the board-to-wire connector 1 and a corresponding wire-to-board connector have been connected and disconnected many times.

Furthermore, the positioning tab 34 at the outer side of the main plate 31 is bent downwardly so that it is adapted for connecting to the circuit board 5 and serving as a solder pin for the circuit board 5.

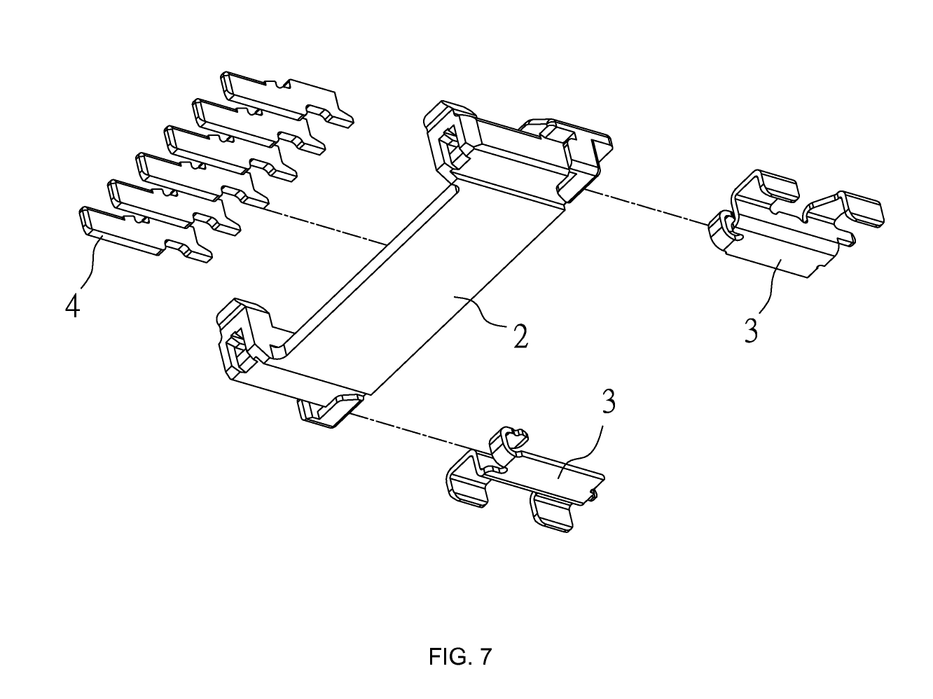

Referring to FIG. 7, in assembling the thickened plastic body 2 and the narrow metal brackets 3, first of all, the rear interference tab 33 of each narrow metal bracket 3 is inserted into the positioning recess 234 of one coupling portions 23 of the plastic body 2. Next, the front interference tab 32 of each narrow metal bracket 3 is bent upwardly and backwardly to be inserted into the engaging recess 233 of one coupling portion 23 of the plastic body 3. Next, the main plate 31 of each narrow metal bracket 3 is bent according to the contour of the coupling portion 23 to form an L-shaped configuration to support the plastic body 2, so that the plastic body 2 can be prevented from being damaged due to an improper force. Next, the positioning tab 34 of each narrow metal bracket 3 is bent downwardly and soldered onto the circuit board 5. Finally, the conductive terminals 4 are fitted through the multiple channels 221 of the raised portion 22 of the plastic body 2, and the solder sections 42 of the conductive terminals 4 serve as solder pins, so that the board-to-wire connector 1 is constructed into a sinking-type structure for reducing the mounting space of the board-to-wire connector 1 and meeting the height limitation for an electronic component. The connecting sections 43 of the conductive terminals 4 are adapted for electrical connection to the conductive terminals of a corresponding wire-to-board connector.

In light of the foregoing, the board-to-wire connector of the present invention, which employs two narrow metal brackets in stead of a large metal support plate used in conventional technology, can reduce the amount of metal material being used in the connector and increase the thickness of the plastic body, so that the connector can withstand multiple repeated connections and disconnections. Furthermore, each coupling portion of the plastic body defines an engaging recess and an positioning recess respectively at its front and rear to be respectively engaged with the front and rear interference tabs of one narrow metal bracket, so that the plastic body and the narrow metal brackets can be assembled more tightly, so that the structural strength of the board-to-wire connector can be increased. Furthermore, in assembling the elements of the present invention, damages of the plastic body due to an improper force can be reduced, so that product yield can be increased and the manufacturing cost can be reduced.

While the invention has been described with reference to the preferred embodiment above, it should be recognized that the preferred embodiment is given for the purpose of illustration only and is not intended to limit the scope of the present invention and that various modifications and changes, which will be apparent to those skilled in the relevant art, may be made without departing from the spirit and scope of the invention.

What is claimed is:

1. A board-to-wire connector for a circuit board, comprising:
a plastic body having a connection plate, a raised portion and two coupling portions at two opposite sides of the raised portion, wherein the raised portion defines multiple channels extending in a longitudinal direction thereof, and each coupling portion is formed at its front with an upright support that has an enlarged top end, away from the connection plate;
a pair of narrow metal brackets, each corresponding to one of the coupling portions, wherein each of the narrow metal brackets comprises:
a main plate connected to outer and bottom sides of the coupling portion corresponding thereto;
front and rear interference tabs extending from the main plate and coupled to the coupling portion; and
at least one positioning tab disposed at an outer side of the main plate and adapted for engagement with the circuit board; and
multiple conductive terminals, each being fitted through a corresponding one of the channels along the longitudinal direction, wherein each of the conductive terminals has a fixed section disposed within the channel corresponding thereto, a solder section extending backwardly from the fixed section for being soldered onto the circuit board, and a connecting section extending forwardly from the fixed section and protruding beyond the plastic plate.

2. The board-to-wire connector of claim 1, wherein the upright support defines at its front an engaging recess for engagement with the front interference tab.

3. The board-to-wire connector of claim 1, wherein each of the coupling portions defines at its rear a positioning recess for engagement with the rear interference tab.

4. The board-to-wire connector of claim 1, wherein each of the narrow metal brackets is formed by bending a metal sheet.

5. The board-to-wire connector of claim 1, wherein the connecting sections are each shaped as a flat plate.
